(19) United States
(12) Patent Application Publication
(10) Pub. No.: US 2011/0292862 A1
(43) Pub. Date: Dec. 1, 2011

(54) RELAY STATION, RELAY METHOD AND WIRELESS COMMUNICATION SYSTEM

(75) Inventor: Masatsugu SHIMIZU, Kawasaki (JP)

(73) Assignee: FUJITSU LIMITED, Kawasaki-shi (JP)

(21) Appl. No.: 13/117,960

(22) Filed: May 27, 2011

(30) Foreign Application Priority Data
May 31, 2010 (JP) 2010-124579

(51) Int. Cl. H04B 7/14

(52) U.S. Cl. 370/315

(57) ABSTRACT

A relay station, that relays wireless communication between a wireless base station and a mobile terminal, includes a processor that detects a connection state of a first link between the wireless base station and the relay station in a wireless communication area, and controls a transmission of a signal using a second link between the mobile terminal and the relay station according to the state of the first link.

### CROSS-REFERENCE TO RELATED APPLICATIONS

This application is based upon and claims the benefit of priority from the prior Japanese Patent Application No. 2010-124579 filed on May 31, 2010, the entire contents of which are incorporated herein by reference.

### FIELD

The present invention relates to a relay station and relay method for relaying wireless communication between, for example, a wireless base station and a mobile terminal, and relates to the technical field of a wireless communication system including a wireless base station, a mobile terminal, and a relay station.

### BACKGROUND

In mobile telephone systems and other wireless communication systems, the placement of wireless base stations is designed to enable wireless communication between a mobile terminal and at least one wireless base station. However, even when multiple wireless base stations exist, dead spots where mobile terminals cannot conduct wireless communication with any wireless base station occur due to geographical constraints or obstructions such as buildings.

Hence, the placement of relay stations has been proposed in, for example, Long Term Evolution Advanced (LTE-A) wireless communication systems to establish wireless communication between a mobile terminal and a wireless base station and eliminate the dead spot. In particular, the placement of relay stations that can handle communication with mobile terminals without differentiating between relay stations and wireless base stations has been proposed in LTE-A to establish compatibility with LTE and other wireless communication systems. Relay stations relay radio waves from wireless base stations to mobile terminals and also relay radio waves from mobile terminals to wireless base stations. As a result, wireless communication may be established between wireless base stations and mobile terminals by using the relay station to handle radio waves in place of the mobile terminal handling radio waves from the wireless base station directly. Alternatively, the relay station may relay radio waves emitted by the mobile terminal to the wireless base station, to the wireless base station. Then the wireless base station may confirm the radio waves from the mobile terminal based on the relayed radio waves and establish the subsequent wireless communication.

Related arts relating to relaying between a mobile terminal and a wireless base station by a relay station are disclosed in, for example, Japanese Laid-open Patent Publication No. 2005-57323, Japanese Laid-open Patent Publication No. 2002-171572, and Japanese Laid-open Patent Publication No. 2002-77987.

### SUMMARY

According to an aspect of the invention, a relay station that relays wireless communication between a wireless base station and a mobile terminal includes a processor that detects a connection state of a first link between the wireless base station and the relay station in a wireless communication area, and controls a transmission of a signal using a second link between the mobile terminal and the relay station according to the state of the first link.

The object and advantages of the invention will be realized and attained by at least the features, elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram of an example configuration of a wireless communication system according to a first embodiment.

FIG. 2 is a block diagram of an eNB hardware configuration according to the first embodiment.

FIG. 3 is a block diagram of a relay station hardware configuration according to the first embodiment.

FIGS. 4A and 4B are block diagrams of hardware configurations of layer 1 processing units in a relay station according to the first embodiment.

FIG. 5 is a block diagram of a UE hardware configuration according to the first embodiment.

FIG. 6 is a block diagram of function blocks of the relay station according to the first embodiment.

FIG. 7 is an exemplary flowchart of operations of the relay station according to the first embodiment.

FIG. 8 is a flowchart illustrating an operation flow of a control unit monitoring the state of a relay link, the control unit being installed in the relay station according to the first embodiment.

FIG. 9 is a block diagram of function blocks of a relay station according to a second embodiment.

FIG. 10 is an exemplary flowchart of operations of the relay station according to the second embodiment.

FIG. 11 is a block diagram of function blocks of a relay station according to a third embodiment.

FIG. 12 is an exemplary flowchart of operations of the relay station according to the third embodiment.

FIG. 13 is a block diagram of function blocks of a relay station according to a fourth embodiment.

FIG. 14 is an exemplary flowchart of operations of the relay station according to the fourth embodiment.

### DESCRIPTION OF EMBODIMENTS

The relay stations proposed in LTE-A include fixed relay stations that are fixed to a non-moving object. Meanwhile, the introduction of mobile relay stations that are placed in a moving object has been envisioned for the convenience of the user. Specifically, the placement of a mobile relay station in a moving object such as a train or automobile has been envisioned. However, the following technical problems can occur with the introduction of mobile relay stations.

For example, a condition where wireless communication between a relay station and a wireless base station cannot be conducted may occur due to the location or environment in which a moving object is traveling when a mobile relay station is placed in the moving object such as a train, an automobile or other moving object. Specifically, when the moving object moves to a position far away from the cover area (also called a “cell”) of the wireless base station, the relay link between the relay station and the wireless base station may be disconnected. In this case, the mobile terminal connected to the relay station will enter a state in which the mobile terminal cannot conduct wireless communication with the wireless base station, though the wireless communication with the wireless base station can be relayed by the relay station. However, the mobile terminal may determine that it is in the cover area (that is, within range) of the wireless base station (or relay station) if the access link is connected between the mobile terminal and the relay station due to the fact that wireless communication can be handled without distinguishing between the relay station or the wireless base station. As a result, the user of the mobile terminal may conduct a transmission operation without knowing that the relay link is disconnected. Since the mobile terminal has also determined that it is in range, the mobile terminal sends a request to connect to a network but communication cannot be established since the connection request is not sent from the relay station to the wireless base station. From the standpoint of the mobile terminal in this case, the mobile terminal operation to conduct transmission is wasteful. From the standpoint of the user, the user may repeatedly try to transmit since the user cannot understand the reason for not being able to communicate despite being in range. This condition is not very convenient from the standpoint of the user.

Preferred embodiments will be described below with reference to the drawings.

### (1) First Embodiment

The following is an explanation of a wireless communication system 1 according to a first embodiment. As an example of the wireless communication system, the following explanation will use a mobile telephone system compliant with Long Term Evolution (LTE). However, the following embodiments may also be applicable to various types of wireless communication systems other than a mobile telephone system compliant with LTE.

(1-1) Configuration of Wireless Communication System

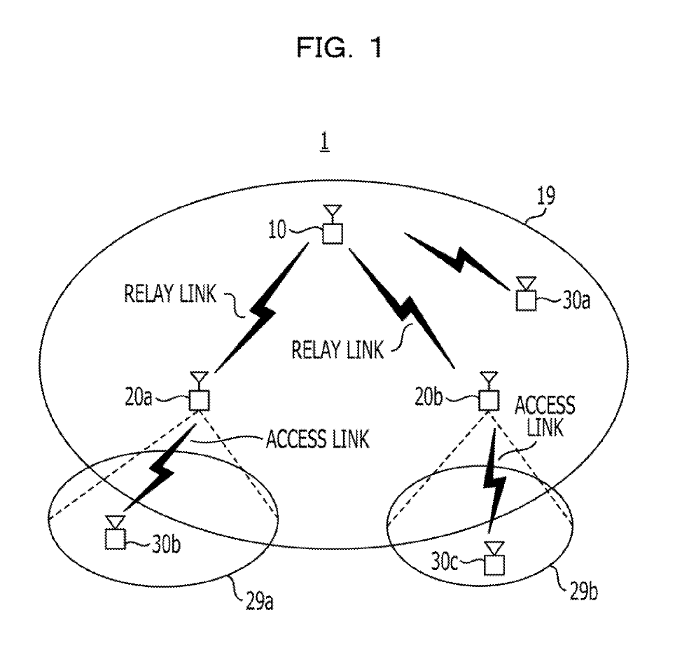

A configuration of the wireless communication system 1 according to the first embodiment will be explained with reference to FIG. 1. FIG. 1 is a block diagram of an example configuration of a wireless communication system according to a first embodiment.

As illustrated in FIG. 1, the wireless communication system 1 according to the first embodiment is equipped with an eNB (evolved Node B) 10, a relay station 20a, a relay station 20b, a UE (User Equipment) 30a, a UE 30b, and a UE 30c. The numbers of the eNB 10, the relay stations 20, and the UEs 30 indicated in FIG. 1 are merely examples and are not limited to those numbers. Also hereinbelow, the relay station 20a and the relay station 20b may be referred to collectively as the “relay station 20” for reasons of explanation. Similarly, the UE 30a, the UE 30b and the UE 30c may be referred to collectively as the “UE 30” in the following explanations.

The eNB 10 is a base station that covers a cell 19 (also called a “macrocell”) with a cell radius of several kilometers to tens of kilometers, to even several tens of kilometers. The eNB 10 conducts wireless transmission between the eNB 10 and the relay stations 20 and between the eNB 10 and the UEs 30, the relay stations 20 and the UEs 30 being located within the cell 19 that the eNB 10 covers. That is, the eNB 10 establishes communication connections to the relay stations 20 and the UEs 30 located within the cell 19 that the eNB 10 covers and conducts the transmission of data to the relay stations 20 and the UEs 30.

The relay stations 20 relay radio waves from the eNB 10 to the UEs 30 located within a relay area 29 covered by each relay stations 20, and also relay radio waves from the UEs 30 located inside the relay area 29 to the eNB 10. As a result, the size and shape of the eNB 10 cell is substantially enlarged and transformed. For example, in FIG. 1, the relay station 20a relays radio waves from the eNB 10 to the UE 30b located within a relay area 29a covered by the relay station 20a, and also relays radio waves from the UE 30b located inside the relay area 29a to the eNB 10. Similarly, in FIG. 1, the relay station 20b relays radio waves from the eNB 10 to the UE 30c located within a relay area 29b covered by the relay station 20b, and also relays radio waves from the UE 30c located inside the relay area 29b to the eNB 10. In the present embodiment, a wireless line between the wireless base station 10 and the relay stations 20 is called a relay link, and the wireless line between the relay stations 20 and the mobile terminals 30 is called an access link.

The placement location of the relay stations 20 may be fixed in substantially the same way as the eNB 10. Conversely, the placement location of the relay stations 20 may also be mobile. For example, the relay stations 20 may be installed in a moving object such as an automobile, a train, an airplane, or a boat.

The UEs 30 are mobile terminals that establish connections with the eNB 10 corresponding to the cell 19 where the UE 30 is located and with the relay station 20 corresponding to the relay area 29 where the UE 30 is located, and conduct data transmission. The UEs 30 may use various services and applications (for example, services such as mail, voice-call, web surfing, and packet communication) through the eNB 10 (furthermore, a host node, not illustrated, connected to the eNB 10 at the top). Examples of UEs 30 include mobile telephones, Personal Digital Assistants (PDAs), and information equipment having wireless transmission functions.

The above explanation provides the example of the eNB 10 that covers the cell 19 with a radius of a few kilometers to several kilometers or even several tens of kilometers (also called a “macrocell”). However, a wireless base station that covers a cell with a radius of several hundred meters to a kilometer (also called a “microcell”), or a wireless base station that covers a cell with a radius of a few meters to several meters or even several tens of meters (also called a “femtocell”) may also be used with or instead of the eNB 10. Moreover, various wireless base stations that cover cells with other radiuses may be provided.

(1-2) Hardware Configuration

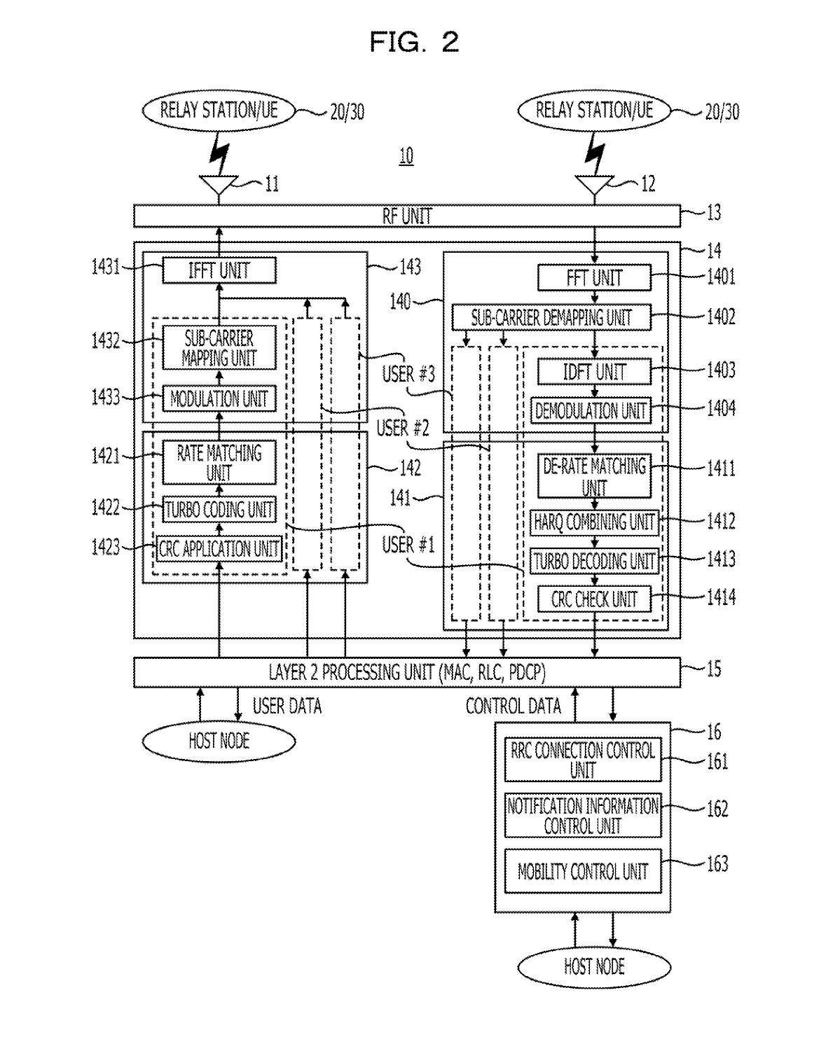

Hardware configurations of the eNB 10, the mobile relay stations 20, and the UEs 30 in the wireless communication system 1 according to the first embodiment will be explained with reference to FIGS. 2 to 5.

(1-2-1) eNB Hardware Configuration

A hardware configuration of the eNB 10 according to the first embodiment will be explained with reference to the FIG. 2. FIG. 2 is a block diagram of the eNB hardware configuration according to the first embodiment.

As illustrated in FIG. 2, the eNB 10 is equipped with a transmitting antenna 11, a receiving antenna 12, an Radio Frequency (RF) unit 13, a layer 1 processing unit 14, a layer 2 processing unit 15, and an Radio Resource Control (RRC) processing unit 16. The RF unit 13 may be implemented by analog circuits. The functions of the layer 1 processing unit 14, the layer 2 processing unit 15, and the RRC processing unit 16 may be realized by Central Processing Unit (CPU), Digital Signal Processor (DSP), and Field Programmable Gate Array (FPGA), etc.

The transmitting antenna 11 transmits downlink signals outputted by the RF unit 13 to relay stations 20 via a relay link. The transmitting antenna 11 may also transmit downlink signals outputted by the RF unit 13 directly to UEs 30.

The receiving antenna 12 receives uplink signals transmitted from the relay stations 20 via the relay link. The receiving antenna 12 may also receive uplink signals transmitted directly from the UEs 30. The receiving antenna 12 outputs the received uplink signals to the RF unit 13.

The RF unit 13 conducts wireless transmission processing (for example, converting signals to high frequency signals) on baseband signals outputted from the layer 1 processing unit 14 when downlink signals are transmitted. The RF unit 13 outputs the processed baseband signals (that is, the downlink signals) to the transmitting antenna 11. The RF unit 13 conducts wireless transmission processing (for example, converting signals to baseband signals) on uplink signals received from the receiving antenna 12 when uplink signals are received. The RF unit 13 outputs the processed uplink signals (that is, the baseband signals) to the layer 1 processing unit 14.

The layer 1 processing unit 14 conducts transmitting and receiving processing related to the layer 1 (physical layer: PHY). Specifically, the layer 1 processing unit 14 includes a demodulation (DEM) processing unit 140 that conducts demodulation, a decoding (DEC) processing unit 141 that conducts decoding processing, a coding (COD) processing unit 142 that conducts coding processing, and a modulation (MOD) processing unit 143 that conducts modulation processing.

The demodulation processing unit 140 conducts demodulation processing conforming to the Single Carrier Frequency Division Multiple Access (SC-FDMA) protocol when uplink signals are received. Specifically, the demodulation processing unit 140 is equipped with an Fast Fourier Transform (FFT) unit 1401 for demodulating symbols, a sub-carrier demapping unit 1402 that separates the demodulated symbols for each user, an Inverse Discrete Fourier Transform (IDFT) unit 1403 that conducts inverse discrete Fourier transform on the symbols separated for each user, and a demodulation unit 1404 that demodulates multilevel modulated symbols, the demodulation conforming to Quadrature Phase Shift Keying (QPSK), 16 Quadrature Amplitude Modulation (QAM), and 64QAM. The IDFT unit 1403 and the demodulation unit 1404 may also be provided individually for each user as illustrated in FIG. 2.

The decoding processing unit 141 conduct decoding processing when uplink signals are received. Specifically, the decoding processing unit 141 is equipped with a de-rate matching unit 1411 that restores data that has been lengthened or shortened according to an assigned physical channel resource to the original data size, an HARQ combining unit 1412 that combines data retransmitted by Hybrid Automatic Repeat Request (HARQ) retransmission processing, a turbo decoding unit 1413 that decodes data that has been turbo coded, and a Cyclic Redundancy Check (CRC) check unit 1414 that checks the redundancy of decoded data. The de-rate matching unit 1411, the HARQ combining unit 1412, the turbo decoding unit 1413, and the CRC check unit 1414 may also be provided individually for each user as illustrated in FIG. 2.

The coding processing unit 142 conducts coding processing when transmitting downlink signals. Specifically, the coding processing unit 142 is equipped with a CRC application unit 1423 that applies CRC to the data, a turbo coding unit 1422 that turbo codes data, and a rate matching unit 1421 that shrinks or lengthens data according to the designated physical channel resource. The CRC application unit 1423, the turbo coding unit 1422, and the rate matching unit 1421 may also be provided individually for each user as illustrated in FIG. 2.

The modulation processing unit 143 conducts modulation processing conforming to the Orthogonal Frequency Division Multiple Access (OFDM) protocol when downlink signals are transmitted. Specifically, the modulation processing unit 143 is equipped with a modulation unit 1433 that conducts multilevel modulation on data conforming QPSK, 16QAM, and 64 QAM; a sub-carrier mapping unit 1432 that assigns modulated data to the designated physical channel resource, and an Inverse Fast Fourier Transform (IFFT) unit 1431 that conducts inverse fast Fourier transform on multiplexed data. The sub-carrier mapping unit 1432 and the modulation unit 1433 may be provided individually for each user as illustrated in FIG. 2.

The layer 2 processing unit 15 conducts the transmission and reception of control data between the layer 2 processing unit 15 and the RRC processing unit 16 and also conducts the transmission and reception of user data between the unit 15 and a core network via a host node (for example, a gateway device) by conducting transmission processing relating to layer 2 (Medium Access Control (MAC) layer). For example, the layer 2 processing unit 15 separates and combines data according to a sub-layer format such as MAC, Radio Link Control (RLC) or Packet Data Convergence Protocol (PDCP), and controls the retransmission of data.

The RRC processing unit 16 conducts transmitting and receiving processing relating to layer 3 (RRC layer). Specifically, the RRC processing unit 16 is equipped with an RRC connection control unit 161 that conducts wireless-resources control such as paging and the establishment and release of calls, a notification information control unit 162 that controls notification information, and a mobility control unit 163 that controls the connection switching of handovers and the like.

(1-2-2) Hardware Block Diagram of Relay Station

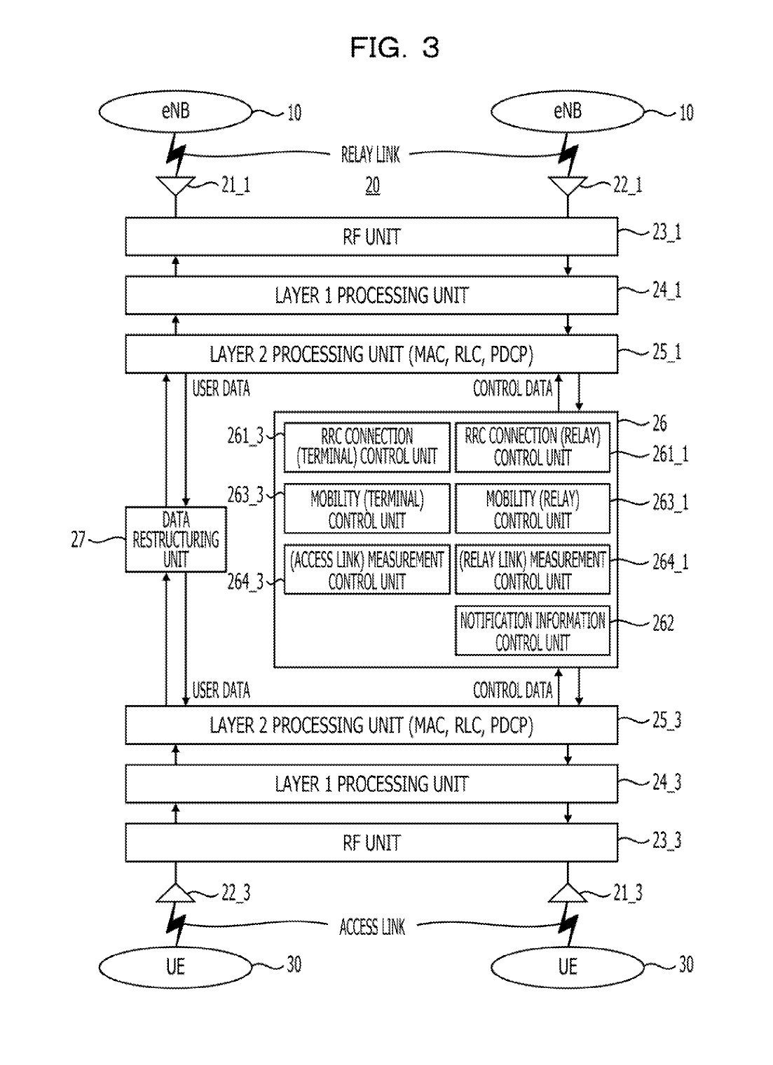

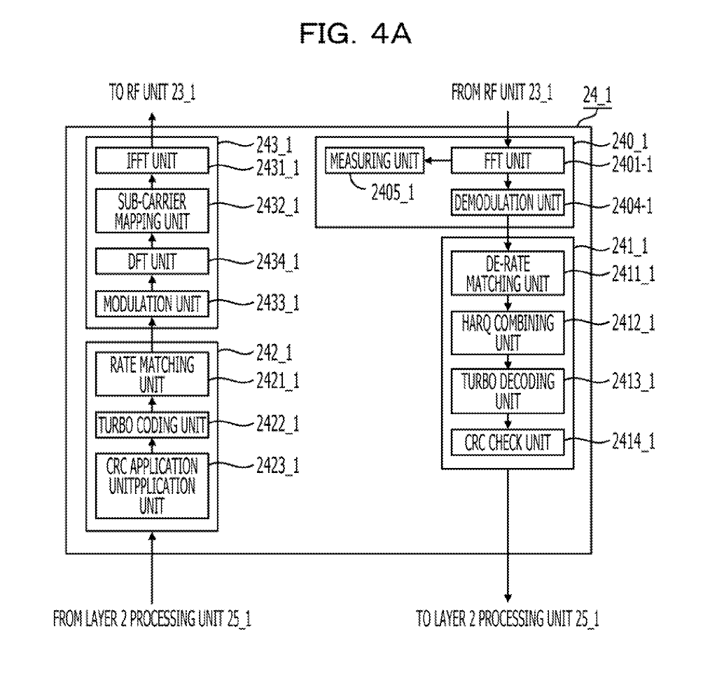

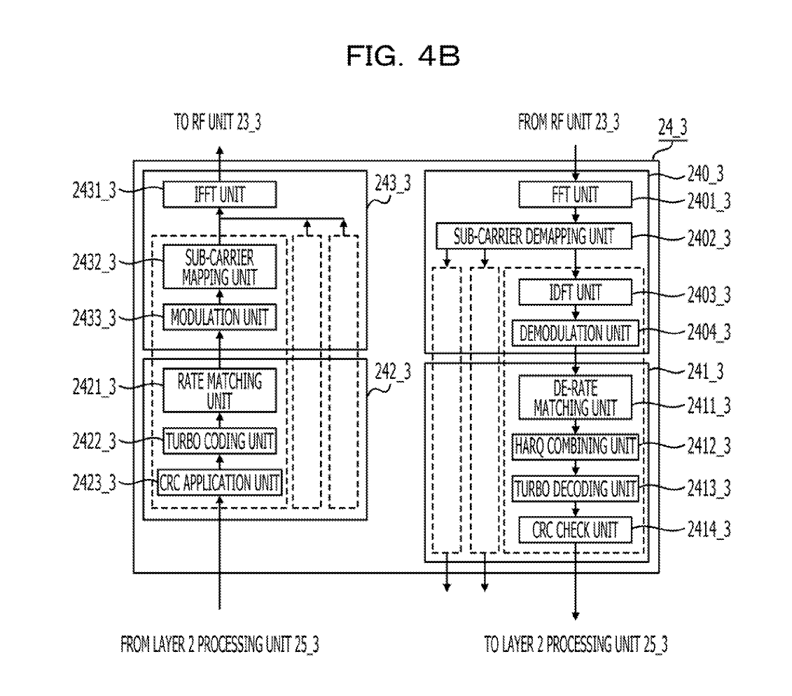

A hardware configuration of the relay station 20 according to the first embodiment will be explained with reference to FIGS. 3 and 4A and 4B. FIG. 3 is a block diagram of the relay station 20 hardware configuration according to the first embodiment. FIGS. 4A and 4B are block diagrams of the hardware configurations of layer 1 processing units 24_1 and 24_3 in the relay station 20 according to the first embodiment.

As illustrated in FIG. 3, the relay station 20 is equipped with a transmitting antenna 21_1, a receiving antenna 22_1, an RF unit 23_1, a layer 1 processing unit 24_1, a layer 2 processing unit 25_1, an RRC processing unit 26, a data restructuring unit 27, a layer 2 processing unit 25_3, a layer 1 processing unit 24_3, a receiving antenna 22_3, and a transmitting antenna 21_3. The RF unit 23_1 may be implemented by analog circuits. The functions of the layer 1 processing unit 24_1, the layer 2 processing unit 25_1, the RRC processing unit 26, the data restructuring unit 27, the layer 2 processing unit 25_3, the layer 1 processing unit 24_3 may be realized by Central Processing Unit (CPU), Digital Signal Processor (DSP), and Field Programmable Gate Array (FPGA), etc.

The transmitting antenna 21_1 transmits uplink signals outputted by the RF unit 23_1 to the eNB 10 via a relay link.

The receiving antenna 22_1 receives downlink signals transmitted from the eNB 10 via the relay link. The receiving antenna 22_1 outputs the received downlink signals to the RF unit 23_1.

The RF unit 23_1 conducts wireless transmission processing on baseband signals outputted from the layer 1 processing unit 24_1 when uplink signals are transmitted via the transmitting antenna 21_1. The RF unit 23_1 outputs the processed baseband signals (that is, the uplink signals) to the transmitting antenna 21_1. The RF unit 23_1 conducts wireless transmission processing on downlink signals received from the receiving antenna 22_1 when downlink signals are transmitted via the receiving antenna 22_1. The RF unit 23_1 outputs the processed downlink signals (that is, the baseband signals) to the layer 1 processing unit 24_1.

The layer 1 processing unit 24_1 conducts transmitting and receiving processing related to layer 1. Specifically, as illustrated in FIG. 4A, the layer 1 processing unit 24_1 is equipped with a demodulation processing unit 240_1 that conducts demodulation processing, a decoding processing unit 241_1 that conducts decoding processing, a coding processing unit 242_1 that conducts coding processing, and a modulation processing unit 243_1 that conducts modulation processing.

The demodulation processing unit 240_1 conducts demodulation processing conforming to the ODFMA protocol when downlink signals are received via the receiving antenna 22_1. Specifically, the demodulation processing unit 240_1 is equipped with an FFT unit 2401_1 for demodulating symbols, a demodulation unit 2404_1 that demodulates the multilevel modulated symbols, and a measuring unit 2405_1 that measures reception levels and conducts cell searching.

The decoding processing unit 241_1 conducts decoding processing when downlink signals are received via the receiving antenna 22_1. Specifically, the decoding processing unit 241_1 is equipped with a de-rate matching unit 2411_1 that restores data that has been lengthened or shortened according to the assigned physical channel resource to the original data size, an HARQ combining unit 2412_1 that combines data retransmitted by HARQ retransmission processing, a turbo decoding unit 2413_1 that decodes data that has been turbo-coded, and a CRC check unit 2414_1 that checks the redundancy of decoded data.

The coding processing unit 242_1 conducts coding processing when uplink signals are transmitted via the transmitting antenna 21_1. Specifically, the coding processing unit 242_1 is equipped with a CRC application unit 2423_1 that applies CRC to the data, a turbo coding unit 2422_1 that turbo-codes data, and a rate matching unit 2421_1 that shrinks or lengthens data according to the designated physical channel resource.

The modulation processing unit 243_1 conducts modulation processing conforming to the SC-FDMA protocol when uplink signals are transmitted via the transmitting antenna 21_1. Specifically, the modulation processing unit 243_1 is equipped with a modulation unit 2433_1 that conducts multilevel modulation of data, a DFT unit 2434_1 that modulates data, a sub-carrier mapping unit 2432_1 that assigns the modulated data to the designated physical channel resource, and an IFFT unit 2431_1 that conducts inverse fast Fourier transform on multiplexed data.

Referring back to FIG. 3, the layer 2 processing unit 25_1 conducts transmission and reception related to layer 2 in substantially the same way as the abovementioned layer 2 processing unit 15 (see FIG. 2).

The RRC processing unit 26 conducts transmitting and receiving processing related to a layer 3. Specifically, the RRC processing unit 26 is equipped with an RRC connection (relay) control unit 261_1 that controls wireless resources of the relay station 20, an RRC connection (terminal) control unit 261_3 that controls wireless resources of the UE 30, a notification information control unit 262 that controls notification information, a mobility (relay) control unit 263_1 that controls connection switching of handovers and the like of relay stations 20, a mobility (terminal) control unit 263_3 that controls connection switching of handovers and the like of UEs 30, a (relay link) measurement control unit 264_1 that controls measurement of the relay link, and an (access link) measurement control unit 264_3 that controls measurement of the access link.

The data restructuring unit 27 restructures data of multiple UEs 30 (that is, multiple user) transmitted together from the eNB 10 into data for each individual UE 30 when data transmitted from the eNB 10 to the UEs 30 is relayed. Conversely, the data restructuring unit 27 restructures data individually transmitted from the UEs 30 as a combined group of data when data transmitted from the UEs 30 to the eNB 10 is relayed.

The layer 2 processing unit 25_3 conducts transmission and reception related to the layer 2 in substantially the same way as the abovementioned layer 2 processing unit 15 (see FIG. 2).

The layer 1 processing unit 24_3 conducts transmitting and receiving processing related to the layer 1. Specifically, as illustrated in FIG. 4B, the layer 1 processing unit 24_3 is equipped with a demodulation processing unit 240_3 that conducts demodulation processing, a decoding processing unit 241_3 that conducts decoding processing, a coding processing unit 242_3 that conducts coding processing, and a modulation processing unit 243_3 that conducts modulation processing.

The demodulation processing unit 240_3 conducts demodulation processing conforming to the SC-FDMA protocol when uplink signals are received via the receiving antenna 22_3. Specifically, the demodulation unit 240_3 is equipped with an FFT unit 2401_3 for demodulating symbols, a sub-carrier demapping unit 2402_3 that separates the demodulated symbols for each user, an IDFT unit 2403_3 that conducts inverse discrete Fourier transform processing on the symbols separated for each user, and a demodulation unit 2404_3 that demodulates multilevel modulated symbols. The IDFT unit 2403_3 and the demodulation unit 2404_3 may also be provided individually for each user as illustrated in FIG. 4B.

The decoding processing unit 241_3 conducts decoding processing when uplink signals are received via the receiving antenna 22_3. Specifically, the decoding processing unit 241_3 is equipped with a de-rate matching unit 2411_3 that restores data that has been lengthened or shortened according to the assigned physical channel resource to the original data size, an HARQ combining unit 2412_3 that combines data retransmitted by HARQ retransmission processing, a turbo decoding unit 2413_3 that decodes data that has been turbo-coded, and a CRC check unit 2414_3 that checks the redundancy of decoded data. The de-rate mapping unit 2411_3, the HARQ combining unit 2412_3, the turbo coding unit 2413_3, and the CRC check unit 2414_3 may also be provided individually for each user as illustrated in FIG. 4B.

The coding processing unit 242_3 conducts coding processing when downlink signals are transmitted via the transmitting antenna 21_3. Specifically, the coding processing unit 242_3 is equipped with a CRC application unit 2423_3 that applies CRC to the data, a turbo coding unit 2422_3 that turbo-codes data, and a rate matching unit 2421_3 that shrinks or lengthens data according to the designated physical channel resource. The CRC application unit 2423_3, the turbo coding unit 2422_3, and the rate matching unit 2421_3 may also be provided individually for each user as illustrated in FIG. 4B.

The modulation processing unit 243_3 conducts modulation processing conforming to the OFDMA protocol when downlink signals are transmitted via the transmitting antenna 21_3. Specifically, the modulation processing unit 243_3 is equipped with a modulation unit 2433_3 that conducts multilevel modulation of data, a sub-carrier mapping unit 2432_3 that assigns the modulated data to the designated physical channel resources, and an IFFT unit 2431_3 that converts multiplexed data to time periods. The sub-carrier mapping unit 2432_3 and the modulation unit 2433_3 may be provided individually for each user as illustrated in FIG. 4B.

The RF unit 23_3 conducts wireless transmission processing (for example, converting signals to high frequency signals) on baseband signals outputted from the layer 1 processing unit 24_3 when downlink signals are transmitted via the transmitting antenna 21_3. The RF unit 23_3 outputs the processed baseband signals (that is, the downlink signals) to the transmitting antenna 21_3. The RF unit 23_3 conducts wireless transmission processing (for example, converting signals to baseband signals) on uplink signals received from the receiving antenna 22_3 when uplink signals are received via the receiving antenna 22_3. The RF unit 23_3 outputs the processed uplink signals (that is, the baseband signals) to the layer 1 processing unit 24_3.

The receiving antenna 22_3 receives uplink signals transmitted from the UEs 30 via the access link. The receiving antenna 22_3 outputs the received uplink signals to the RF unit 23_3.

The transmitting antenna 21_3 transmits downlink signals outputted from the RF unit 23_3 to the UEs 30 via the access link.

(1-2-3) UE Block Diagram

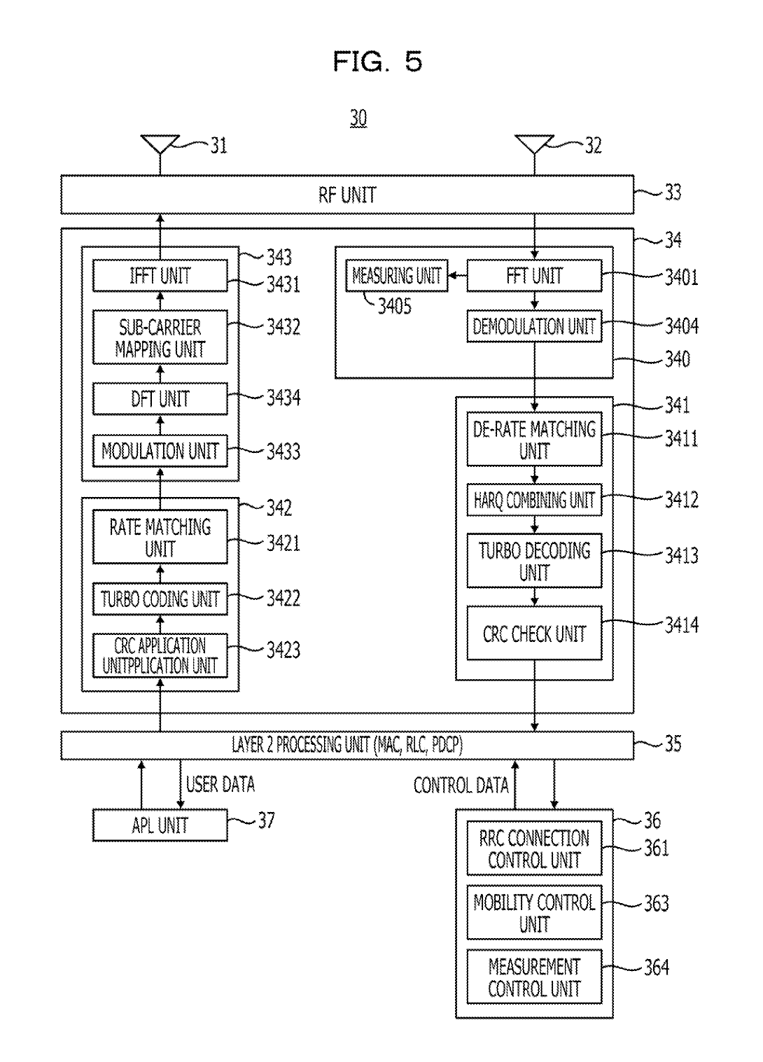

A hardware configuration of the UE 30 according to the first embodiment will be explained with reference to the FIG. 5. FIG. 5 is a block diagram of a hardware configuration of the UE 30 according to the first embodiment.

The UE 30 is equipped with a transmitting antenna 31, a receiving antenna 32, an RF unit 33, a layer 1 processing unit 34, a layer 2 processing unit 35, an RRC processing unit 36, and an APL (Application) unit 37. The RF unit 33 may be implemented by analog circuits. The functions of the layer 1 processing unit 34, the layer 2 processing unit 35, the RRC processing unit 36, the APL unit 37 may be realized by Central Processing Unit (CPU), Digital Signal Processor (DSP), and Field Programmable Gate Array (FPGA), etc.

The transmitting antenna 31 transmits uplink signals outputted by the RF unit 33 to the relay station 20 via a relay link. The transmitting antenna 31 may also transmit uplink signals outputted by the RF unit 33 directly to the eNB 10.

The receiving antenna 32 receives downlink signals transmitted from the relay station 20 via the access link. The receiving antenna 32 may also receive downlink signals transmitted directly from the eNB 10. The receiving antenna 32 outputs the received downlink signals to the RF unit 33.

The RF unit 33 conducts wireless transmission processing on baseband signals outputted from the layer 1 processing unit 34 when uplink signals are transmitted. The RF unit 33 outputs the processed baseband signals (that is, the uplink signals) to the transmitting antenna 31. The RF unit 33 conducts wireless transmission processing on downlink signals received from the receiving antenna 32 when transmitting downlink signals. The RF unit 33 outputs the processed downlink signals (that is, the baseband signals) to the layer 1 processing unit 34.

The layer 1 processing unit 34 conducts transmitting and receiving processing related to layer 1. Specifically, the layer 1 processing unit 34 is equipped with a demodulation processing unit 340 that conducts demodulation processing, a decoding processing unit 341 that conducts decoding processing, a coding processing unit 342 that conducts coding processing, and a modulation processing unit 343 that conducts modulation processing.

The demodulation processing unit 340 conducts demodulation processing conforming to the ODFMA protocol when downlink signals are received. Specifically, the demodulation processing unit 340 is equipped with an FFT unit 3401 for demodulating symbols, a demodulation unit 3404 that demodulates the multilevel modulated symbols, and a measuring unit 3405 that measures reception levels and conducts cell searching.

The decoding processing unit 341 conducts decoding processing when downlink signals are received. Specifically, the decoding processing unit 341 is equipped with a de-rate matching unit 3411 that restores data that has been lengthened or shortened according to the assigned physical channel resource to the original data size, an HARQ combining unit 3412 that combines data retransmitted by HARQ retransmission processing, a turbo decoding unit 3413 that decodes data that has been turbo-coded, and a CRC check unit 3414 that checks the redundancy of the decoded data.

The coding processing unit 342 conducts coding processing when uplink signals are transmitted. Specifically, the coding processing unit 342 is equipped with a CRC application unit 3423 that applies CRC to the data, a turbo coding unit 3422 that turbo-codes data, and a rate matching unit 3421 that shrinks or lengthens the data according to the designated physical channel resource.

The modulation processing unit 343 conducts modulation processing conforming to the SC-FDMA protocol when downlink signals are transmitted. Specifically, the modulation processing unit 343 is equipped with a modulation unit 3433 that conducts multilevel modulation, a DFT unit 3434 that modulates the data, a sub-carrier mapping unit 3432 that assigns the modulated data to the designated physical channel resources, and an IFFT unit 3431 that conducts inverse fast Fourier transform on multiplexed data.

A layer 2 processing unit 35 conducts transmission and reception related to the layer 2 in substantially the same way as the abovementioned layer 2 processing unit 15 (see FIG. 2).

The RRC processing unit 36 conducts transmitting and receiving processing related to the layer 3. Specifically, the RRC processing unit 36 is equipped with an RRC connection control unit 361 that controls wireless resources, a mobility control unit 363 that controls the connection switching of handovers and the like, and a measurement control unit 364 that controls measurements.

The APL unit 37 corresponds to a host layer that processes user data.

(1-3) Relay Station Function Block Diagram

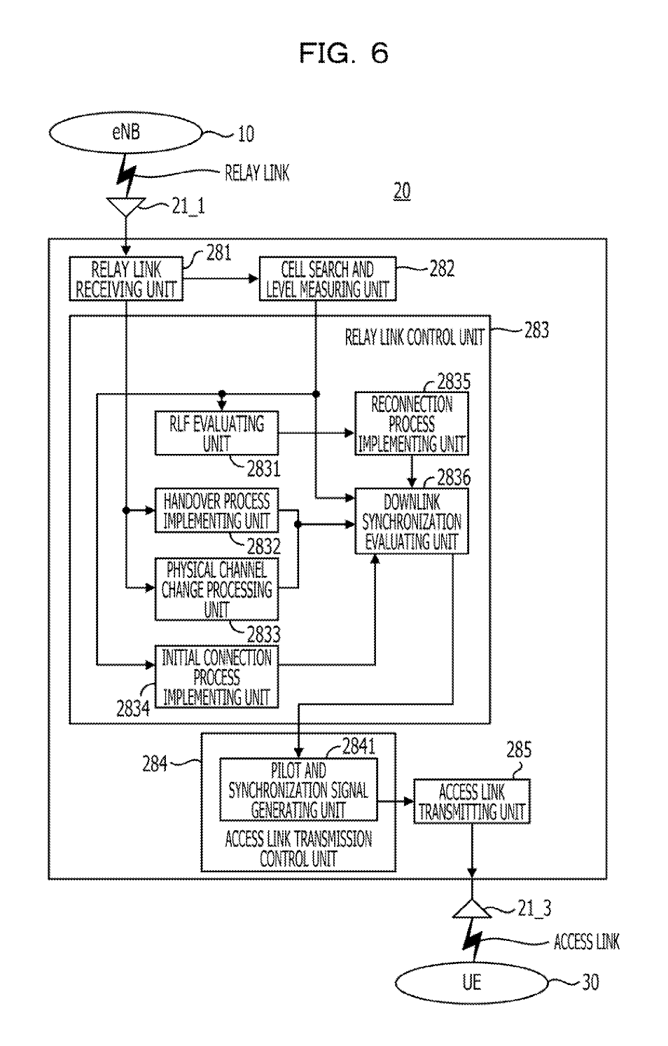

Function blocks of the relay station 20 according to the first embodiment will be explained with reference to FIG. 6. FIG. 6 is a block diagram of function blocks of the relay station 20 according to the first embodiment.

As illustrated in FIG. 6, the relay station 20 is equipped with a relay link receiving unit 281, a cell search and level measuring unit 282, a relay link control unit 283, an access link transmission control unit 284, and an access link transmitting unit 285.

The relay link receiving unit 281 receives downlink signals transmitted from the eNB 10 via the relay link. The relay link receiving unit 281 outputs the received downlink signals to both the cell search and level measuring unit 282 and the relay link control unit 283.

The cell search and level measuring unit 282 searches for a nearby eNB 10 and measures the reception level of the signals from the found eNB 10 from downlink signals transmitted by the eNB 10 via the relay link. The cell search and level measuring unit 282 outputs the measured reception level to the relay link control unit 283.

The relay link control unit 283 controls various processes related to the relay link. The relay link control unit 283 is equipped with a Radio Link Failure (RLF) evaluating unit 2831, a handover process implementing unit 2832, a physical channel change processing unit 2833, an initial connection process implementing unit 2834, a reconnection process implementing unit 2835, and a downlink synchronization evaluating unit 2836.

The RLF evaluating unit 2831 evaluates whether or not an error occurs in the downlink synchronization based on the reception level measured by the cell search and level measuring unit 282. The RLF evaluating unit 2831 outputs the evaluation result to the reconnection process implementing unit 2835.

The handover process implementing unit 2832 implements handover processing based on a control message included in a downlink synchronization signal outputted by the relay link receiving unit 281. The handover process implementing unit 2832 outputs the control message indicating the implementation of the handover processing to the downlink synchronization evaluating unit 2836.

The physical channel change processing unit 2833 changes the designated physical channel or the physical channel used by the relay station 20 based on the control message included in the downlink synchronization signal outputted by the relay link receiving unit 281. The physical channel change processing unit 2833 outputs the control message indicating the change of the physical channel to the downlink synchronization evaluating unit 2836.

The initial connection process implementing unit 2834 conducts the initial processing (for example, turning the power of the relay station 20 on) for the connection of the relay station 20 to the eNB 10. The initial connection process implementing unit 2834 outputs a control message indicating that the initial connection processing has been conducted to the downlink synchronization evaluating unit 2836.

The reconnection process implementing unit 2835 reconnects the relay station 20 to the eNB 10 based on the evaluation results from the RLF evaluating unit 2831. The reconnection process implementing unit 2835 outputs a control message indicating that the reconnection processing has been conducted to the downlink synchronization evaluating unit 2836.

The downlink synchronization evaluating unit 2836, which is an example of a “detecting unit,” determines whether or not synchronization of the relay link (for example, a downward relay link) has been established. In other words, the downlink synchronization evaluating unit 2836 determines whether or not there is a connection state between the eNB 10 and the relay station 20 via the relay link (for example, a downward relay link). The downlink synchronization evaluating unit 2836 outputs the evaluation results to the access link transmission control unit 284. The operation to determine whether or not synchronization of the relay link is established is conducted, for example, based on whether or not a known signal such as a pilot signal may can be received at or over a certain time and at or over a certain reception quality level.

The access link transmission control unit 284 controls various processes related to the access link. The access link transmission control unit 284 is equipped with a pilot and synchronization signal generating unit 2841 that is an example of a “control unit.” The pilot and synchronization signal generating unit 2841 decides to generate or not generate pilot and synchronization signals based on the evaluation result from the downlink synchronization evaluating unit 2836. The pilot and synchronization signal generating unit 2841 controls operations of the access link transmitting unit 285 based on the result of the decision.

The access link transmitting unit 285 transmits downlink signals to the UEs 30 via the access link.

The relay link receiving unit 281 is a function block implemented, for example, by the demodulation unit 240_1 and the decoding processing unit 241_1 of the layer 1 processing unit 24_1 illustrated in FIG. 3 and FIG. 4A. The cell search and level measuring unit 282 is a function block implemented, for example, by the measuring unit 2405_1 of the layer 1 processing unit 24_1 illustrated in FIG. 3 and FIG. 4A. The relay link control unit 283 is a function block implemented, for example, by the RRC processing unit 26 illustrated in FIG. 3. More specifically, the RLF evaluating unit 2831 is a function block implemented, for example, by the RRC connection (relay) control unit 261_1 of the RRC processing unit 26 illustrated in FIG. 3. The handover process implementing unit 2832 is a function block implemented, for example, by the mobility (relay) control unit 263_1 of the RRC processing unit 26 illustrated in FIG. 3. The physical channel change processing unit 2833 is a function block implemented, for example, by the RRC connection (relay) control unit 261_1 of the RRC processing unit 26 illustrated in FIG. 3. The initial connection process implementing unit 2834 is a function block implemented, for example, by the RRC connection (relay) control unit 261_1 of the RRC processing unit 26 illustrated in FIG. 3. The reconnection process implementing unit 2835 is a function block implemented, for example, by the RRC connection (relay) control unit 261_1 of the RRC processing unit 26 illustrated in FIG. 3. The downlink synchronization evaluating unit 2836 is a function block implemented, for example, by the RRC connection (relay) control unit 261_1 and the mobility (relay) control unit 263_1 of the RRC processing unit 26 illustrated in FIG. 3. The access link transmission control unit 284 is a function block implemented, for example, by the RRC processing unit 26 illustrated in FIG. 3. More specifically, the pilot and synchronization signal generating unit 2841 is a function block implemented, for example, by the RRC connection (terminal) control unit 261_3 of the RRC processing unit 26 illustrated in FIG. 3. The access link transmitting unit 285 is a function block implemented, for example, by the modulation processing unit 243_3 and the coding processing unit 242_3 of the layer 1 processing unit 24_3 illustrated in FIG. 3 and FIG. 4B. However, the association of the function blocks of the relay station 20 illustrated in FIG. 6 and the hardware configuration of the relay station 20 illustrated in FIGS. 3, 4A and 4B are examples, and the relay station 20 may be equipped with function blocks with examples of associations other than those explained above.

(1-4) Operation Explanation

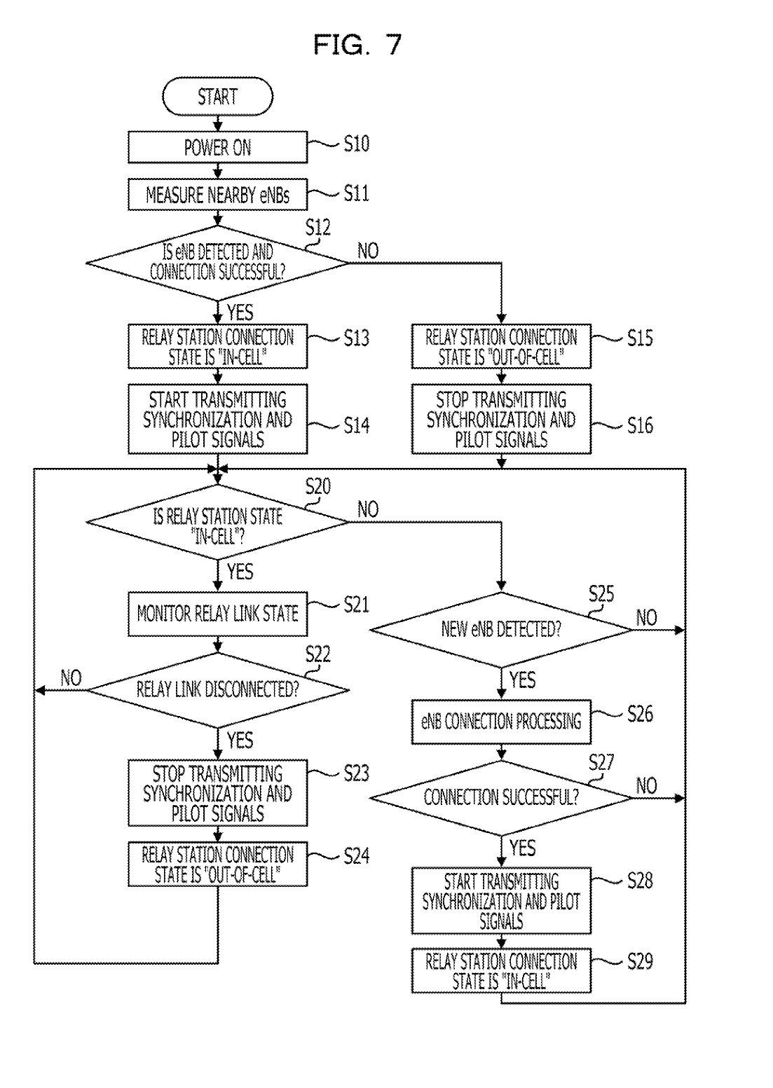

Operations of the relay station 20 included in the wireless communication system 1 according to the first embodiment will be explained with reference to FIG. 7. FIG. 7 is an exemplary flowchart of operations of the relay station 20 according to the first embodiment.

The power of the relay station 20 is switched from off to on (Step S10) as illustrated in FIG. 7.

After turning the power on, the cell search and level measuring unit 282 included in the relay station 20 searches for eNBs 10 (or cells 19) near the relay station 20 and measures the reception level of the signals from the found eNBs 10 (Step S11). The reception signal level received from the nearby eNBs 10 measured by the cell search and level measuring unit 282 is outputted to the initial connection process implementing unit 2834.

The initial connection process implementing unit 2834 determines whether or not a connectable eNB 10 near the relay station 20 may be detected based on the reception levels measured by the cell search and level measuring unit 282 (Step S12). Moreover, the initial connection process implementing unit 2834 conducts initial connection processing with the detected eNB 10 when a connectable eNB 10 near the relay station 20 is detected (Step S12). In addition, the downlink synchronization evaluating unit 2836 evaluates whether or not the initial connection processing conducted by the initial connection process implementing unit 2834 is successful by evaluating whether or not synchronization of the relay link (for example, a downward relay link) is established (Step S12).

When a connectable eNB 10 is detected near the relay station 20 and the initial connection processing conducted with the detected eNB 10 is successful (Step S12: Yes), the downlink synchronization evaluating unit 2836 sets the relay station 20 state (connection state) to an in-cell state (Step S13). Then, the pilot and synchronization signal generating unit 2841 causes the access link transmitting unit 285 to generate a pilot signal and a synchronization signal (Step S13). The access link transmitting unit 285 transmits a downlink signal including the pilot signal and the synchronization signal to the UE 30 via the access link (Step S14). As a result, the UE 30 that tries to start wireless communication with, for example, a new relay station 20 may start wireless communication with the relay station 20 by detecting the synchronization signal. Alternatively, the UE 30 that has already started wireless communication with, for example, a known relay station 20 may continue wireless communication with the relay station 20 by detecting the pilot signal. Thus, the state of the UE 30 becomes an in-cell state.

Conversely, when a connectable eNB 10 near the relay station 20 is not detected or the initial connection processing conducted with a detected eNB 10 is not successful (Step S12: No), the downlink synchronization evaluating unit 2836 sets the relay station 20 state to an out-of-cell state (Step S15). Then, the pilot and synchronization signal generating unit 2841 causes the access link transmitting unit 285 to not generate the pilot signal or the synchronization signal (Step S15). The access link transmitting unit 285 transmits a downlink signal that does not include the pilot signal or the synchronization signal to the UE 30 via the access link (Step S16). As a result, the UE 30 that tries to start wireless communication with, for example, a new relay station 20 does not start wireless communication with the relay station 20 since the UE 30 does not detect the synchronization signal. Alternatively, the UE 30 that has already started wireless communication with, for example, a known relay station 20 does not continue wireless communication with the relay station 20 since the UE 30 does not detect the pilot signal. Thus, the state of the UE 30 becomes an out-of-cell state.

The abovementioned operations correspond to initial operations conducted at the timing when the power of the relay station 20 is switched from off to on. Subsequent to the initial operations, steady-state operations conducted while the power of the relay station 20 is on will be explained below.

The downlink synchronization evaluating unit 2836 determines whether or not the state of the relay station 20 is set as the in-cell state (Step S20).

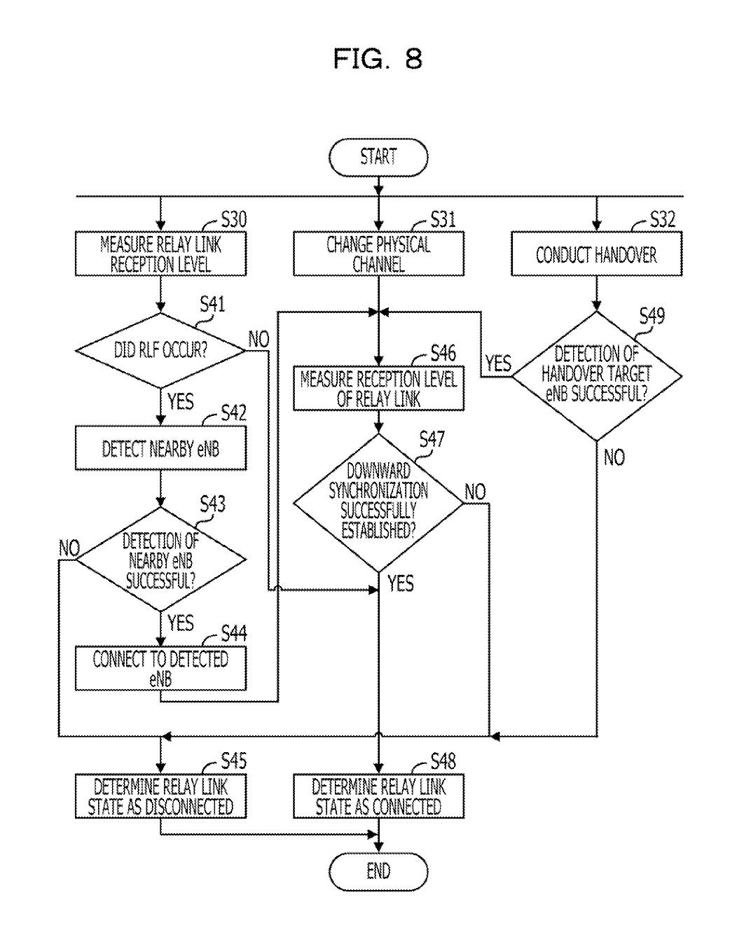

When the state of the relay station 20 is determined as the in-cell state as a result of the determination in Step S20 (Step S20: Yes), the relay link control unit 283 monitors the state of the relay link (Step S21). The operations of monitoring the state of the relay link will be explained below with reference to FIG. 8. FIG. 8 is a flowchart illustrating an operation flow of the relay link control unit 283 monitoring the state of the relay link, the relay link control unit 283 being installed in the relay station 20 according to the first embodiment.

As illustrated in FIG. 8, the operations to monitor the state of the relay link accompany, for example, (i) measuring the reception level of the signals of the relay link, (ii) changing the physical channel, and (iii) conducting the handover process.

Specifically, when monitoring the state of the relay link while measuring the reception level of the signals of the relay link, the cell search and level measuring unit 282 measures the reception level thereof of the relay link at a periodic or voluntary timing (Step S30). Then, the RLF evaluating unit 2831 evaluates whether or not an error occurs in the downlink synchronization (that is, whether the RLF occurs or not) based on the reception level measured by the cell search and level measuring unit 282 (Step S41).

When the RLF has occurred, which is found according to the result of the evaluation in Step S41 (Step S41: Yes), the cell search and level measuring unit 282 detects nearby eNBs 10 based on the cell search process and measures the reception levels of the signals from the detected eNBs 10. Then, the reconnection process implementing unit 2835 determines whether or not a connectable eNB 10 near the relay station 20 may be detected based on the reception levels measured by the cell search and level measuring unit 282 (Step S42).

When the detection of a connectable eNB 10 near the relay station 20 is determined (Step S43: Yes), the reconnection process implementing unit 2835 conducts reconnection processing with the detected eNB 10 (Step S44). Then, the cell search and level measuring unit 282 measures the reception level of the signals of the relay link between the reconnected eNB 10 and the relay station 20 (Step S46). Next, the downlink synchronization evaluating unit 2836 determines whether or not synchronization of the downward relay link is established based on the reception level measured in Step S46 (Step S47). When establishment of synchronization of the downward relay link is determined from the results of the evaluation in Step S47 (Step S47: Yes), the downlink synchronization evaluating unit 2836 determines that the state of the relay link is a connection state (Step S48). Alternatively, when no establishment of synchronization of the downward relay link is determined from the results of the evaluation in Step S47 (Step S47: No), the downlink synchronization evaluating unit 2836 determines that the state of the relay link is in a disconnected state (Step S45).

Alternatively, when it is determined that a RLF has not occurred (Step S41: No), the downlink synchronization evaluating unit 2836 determines that the state of the relay link is a connection state (Step S48). Alternatively, when it is determined that a connectable eNB 10 near the relay station 20 is not detected (Step S43: No), the downlink synchronization evaluating unit 2836 determines that the state of the relay link is a disconnected state (Step S45).

When monitoring of the state of the relay link accompanies the change of the physical channel, the physical channel change processing unit 2833 changes the physical channel (Step S31), and the cell search and level measuring unit 282 measures the reception level of the signals of the relay link (Step S46). Next, the downlink synchronization evaluating unit 2836 determines whether or not synchronization of the downward relay link is established based on the reception level measured in Step S46 (Step S47). When establishment of synchronization of the downward relay link is determined from the results of the evaluation in Step S47 (Step S47: Yes), the downlink synchronization evaluating unit 2836 evaluates the connection state of the relay link (Step S48). Alternatively, when no establishment of synchronization of the downward relay link is determined from the results of the evaluation in Step S47 (Step S47: No), the downlink synchronization evaluating unit 2836 determines that the state of the relay link is in a disconnected state (Step S48).

When the monitoring of the relay link state accompanies conducting the handover processing, the handover process implementing unit 2832 conducts handover processing (Step S32) and then it is determined whether or not detection of a handover target eNB 10 is successful (Step S49). When it is determined that detection of the handover target eNB 10 is successful as a result of the determination in Step S49 (Step S49: Yes), the cell search and level measuring unit 282 measures the reception level of the signals of the relay link (Step S46), and the downlink synchronization evaluating unit 2836 determines whether or not a downward relay link has been established (Step S47). When establishment of synchronization of the downward relay link is determined (Step S47: Yes), the downlink synchronization evaluating unit 2836 evaluates the connection state of the relay link (Step S48). Alternatively, when it is determined that synchronization of the downward relay link has not been established (Step S47: No), or when it is determined that detection of a handover target eNB 10 has not been successful (Step S49: No), the downlink synchronization evaluating unit 2836 determines that the state of the relay link is a disconnected state (Step S45).

Returning to FIG. 7, the downlink synchronization evaluating unit 2836 determines whether or not the state of the relay link is a disconnected state (Step S22).

When it is determined that the state of the relay link is a connection state from the results of the determination in Step S22 (Step S22: No), the relay link control unit 283 repeats the operations from Step S20.

Alternatively, when it is determined that the state of the relay link is a disconnected state from the results of the determination in Step S22 (Step S22: Yes), the pilot and synchronization signal generating unit 2841 causes the access link transmitting unit 285 to not generate a pilot signal or a synchronization signal (Step S23). The downlink synchronization evaluating unit 2836 sets the state of the relay station 20 as an out-of-cell state (Step S24). The access link transmitting unit 285 transmits a downlink signal that does not include the pilot signal or the synchronization signal to the UE 30 via the access link. Thus, as explained above, the state of the UE 30 becomes the out-of-cell state. Next, the relay link control unit 283 repeats the operations from step S20.

Alternatively, when it is determined that the state of the relay station 20 is not the in-cell state from the results of the evaluation in Step S20 (Step S20: No), the cell search and level measuring unit 282 detects the nearby eNBs 10 based on the cell search process and measures the reception levels of the signals from the detected eNBs 10. Then, the initial connection process implementing unit 2834 determines whether or not a new connectable eNB 10 near the relay station 20 is detected based on the reception levels measured by the cell search and level measuring unit 282 (Step S25).

When it is determined that a new connectable eNB 10 near the relay station 20 is not detected from the results of the determination in step S25 (Step S25: No), the relay link control unit 283 repeats the operations from Step S20.

Alternatively, when the detection of a new connectable eNB 10 near the relay station 20 is determined from the results of the determination in Step S25 (Step S25: Yes), the initial connection process implementing unit 2834 conducts initial connection processing with the detected eNB 10 (Step S26). The initial connection process implementing unit 2834 then evaluates whether or not connection processing is successful (Step S27).

When it is determined that the connection processing is not successful from the results of the determination in step S27 (Step S27: No), the relay link control unit 283 repeats the operations from Step S20.

Alternatively, when it is determined that the connection processing is successful from the results of the determination in Step S27 (Step S27: Yes), the pilot and synchronization signal generating unit 2841 causes the access link transmitting unit 285 to generate a pilot signal and a synchronization signal (Step S28). Moreover, the downlink synchronization evaluating unit 2836 sets the state of the relay station 20 to the in-cell state (Step S29). As a result, the access link transmitting unit 285 transmits a downlink signal including the pilot signal and the synchronization signal to the UE 30 via the access link. Thus, the state of the UE 30 becomes the in-cell state. Next, the relay link control unit 283 repeats the operations from step S20.

According to the wireless communication system 1 of the first embodiment explained above, when the state of the relay link between the eNB 10 and the relay station 20 is a disconnected state, transmission of the pilot signal and the synchronization signal from the relay station 20 to the UE 30 may be stopped. As a result, the UE 30 is switched to an out-of-cell state when the state of the relay link is a disconnected state. Thus, a desirable control of the problem of the user of the UE 30 continuing to conduct wasteful transmission operations is possible, and wasteful repeated transmissions from the UE 30 may be prevented. Therefore, unnecessary operations from the UE 30 side may be reduced and convenience for the user is improved.

### (2) Second Embodiment

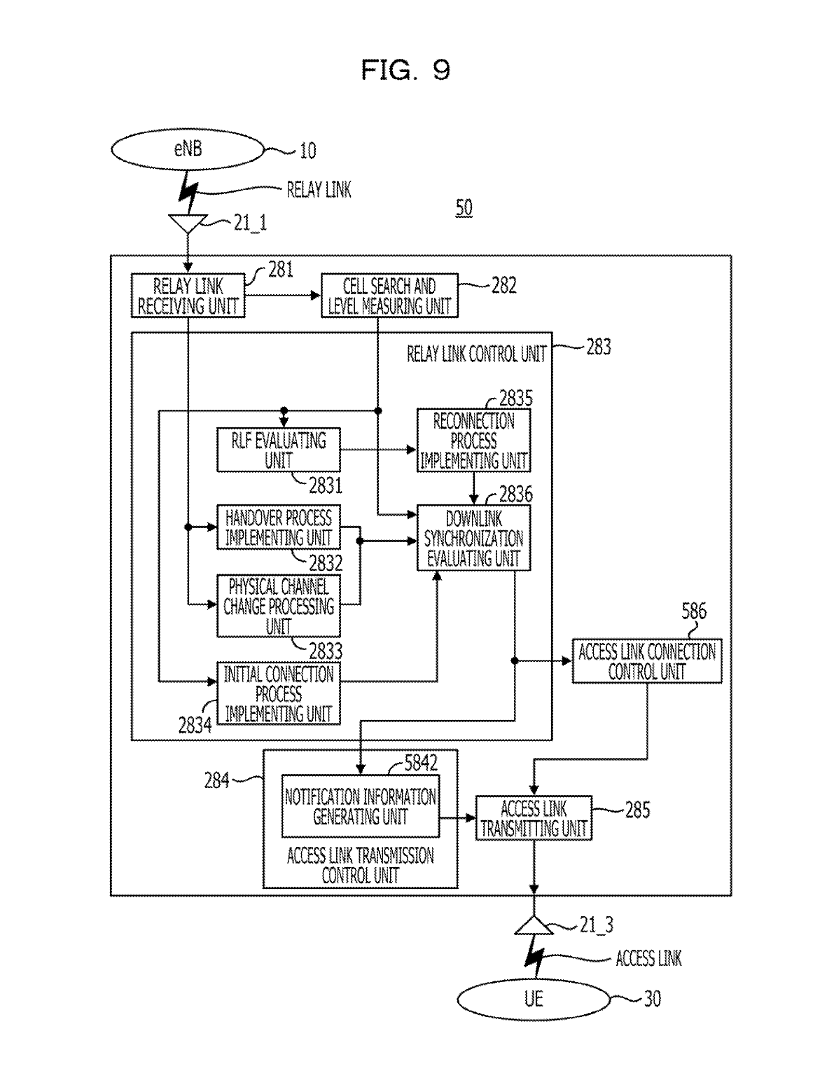

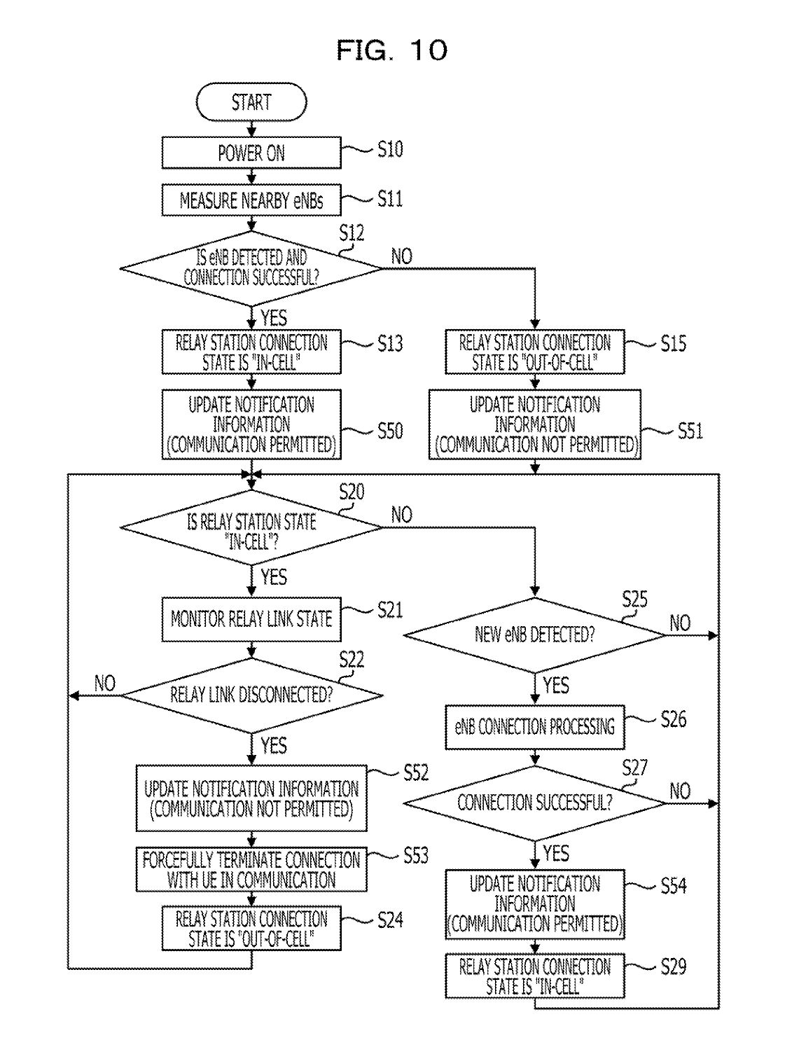

A wireless communication system according to a second embodiment will be explained herein with reference to FIGS. 9 and 10. Function blocks and operations of a relay station 50 the wireless communication system 2 of the second embodiment are different than those of the wireless communication system 1 of the first embodiment. Hence, the following explanation will focus on the operations and configurations that are different from the first embodiment. Configurations and operations that are substantially the same as the wireless communication system 1 of the first embodiment are assigned the same reference numerals and their description is omitted here.

(2-1) Relay Station Function Block Diagram

Function blocks of the relay station 50 included in the wireless communication system of the second embodiment will be explained with reference to FIG. 9. FIG. 9 is a block diagram of function blocks of the relay station 50 according to the second embodiment.

As illustrated in FIG. 9, the relay station 50 according to the second embodiment is equipped with the relay link receiving unit 281, the cell search and level measuring unit 282, the relay link control unit 283, the access link transmission control unit 284, and the access link transmitting unit 285 in substantially the same way as the relay station 20 of the first embodiment.

The relay station 50 of the second embodiment is also equipped with an access link connection control unit 586. The access link connection control unit 586 transmits an instruction to disconnect a call to the UE 30 connected with the relay station 50 by transmitting a call disconnection message through the access link transmitting unit 285.

Further, in the second embodiment, the access link transmission control unit 284 is equipped with a notification information generating unit 5842 as an example of a “control unit” in place of the abovementioned pilot and synchronization signal generating unit 2841 (see FIG. 6). The notification information generating unit 5842 generates notification information to be sent to all the UEs 30 located in the relay area 29 of the relay station 50, and also causes the access link transmitting unit 285 to transmit the notification information.

The access link connection control unit 586 is a function block implemented, for example, by the RRC connection (terminal) control unit 261_3 of the RRC processing unit 26 illustrated in FIG. 3. The notification information generating unit 5842 is a function block implemented, for example, by the information notification control unit 262 of the RRC processing unit 26 illustrated in FIG. 3.

(2-2) Operation Explanation

Operations of the relay station 50 included in the wireless communication system 2 according to the second embodiment will be explained with reference to FIG. 10. FIG. 10 is an exemplary flowchart of operations of the relay station 50 according to the second embodiment.

As illustrated in FIG. 10, the power of the relay station 50 according to the second embodiment is switched from off to on in substantially the same way as the relay station 20 of the first embodiment. After turning the power on, the cell search and level measuring unit 282 searches for an eNB 10 near the relay station 20 and measures the reception level of the signals from the found eNB 10 (Step S11). Then, the initial connection process implementing unit 2834 determines whether or not a connectable eNB 10 near the relay station 50 can be detected based on the reception levels measured by the cell search and level measuring unit 282 (Step S12). Moreover, the initial connection process implementing unit 2834 conducts initial connection processing with the detected eNB 10 when a connectable eNB 10 near the relay station 50 is detected (Step S12). In addition, the downlink synchronization evaluating unit 2836 evaluates whether or not the initial connection processing conducted by the initial connection process implementing unit 2834 is successful or not by evaluating whether or not synchronization of the relay link (for example, the downward relay link) is established (Step S12).

When a connectable eNB 10 is detected near the relay station 50 and the initial connection processing conducted with the detected eNB 10 is successful (Step S12: Yes), the downlink synchronization evaluating unit 2836 sets the relay station 50 state to an in-cell state (Step S13). Then, the notification information generating unit 5842 generates notification information that indicates that wireless communication using the access link between the relay station 50 and the UE 30 is permitted, and also causes the access link transmitting unit 285 to transmit the notification information (Step S50). The access link transmitting unit 285 transmits downlink signals including the notification information to the UEs 30 via the access link. The UE 30 that receives the downlink signals including the notification information recognizes the permission of wireless communication between the UE 30 and the relay station 50 by referring to the notification information. Thus, the UE 30 can start or continue wireless communication with the relay station 50.

Conversely, when a connectable eNB 10 near the relay station 50 is not detected or the initial connection processing conducted with a detected eNB 10 is not successful (Step S12: No), the downlink synchronization evaluating unit 2836 sets the relay station 50 state to the out-of-cell state (Step S15). Then, the notification information generating unit 5842 generates notification information that indicates that wireless communication using the access link between the relay station 50 and the UE 30 is not permitted, and also causes the access link transmitting unit 285 to transmit the notification information (Step S51). The access link transmitting unit 285 transmits downlink signals including the notification information to the UEs 30 via the access link. The UE 30 that receives the downlink signals including the notification information recognizes the stoppage of wireless communication between the UE 30 and the relay station 50 by referring to the notification information. Thus, the UE 30 may stop wireless communication with the relay station 50. The UE 30 that receives the notification information instructing the stoppage of wireless communication using the access link between the relay station 50 and the UE 30 may emit a warning sound and display a predetermined warning to notify the user that the wireless communication is stopped.

The abovementioned operations correspond to initial operations conducted at the timing when the power of the relay station 50 is switched from off to on. Subsequent to the initial operations, steady operations conducted while the power of the relay station 50 is on will be explained below.

The downlink synchronization evaluating unit 2836 determines whether or not the state of the relay station 50 is set as the in-cell state (Step S20).

As a result of the determination in Step S20, when the state of the relay station 50 is determined as the in-cell state (Step S20: Yes), the relay link control unit 283 monitors the state of the relay link (Step S21). While monitoring the state of the relay link, the downlink synchronization evaluating unit 2836 determines whether or not the state of the relay link is disconnected (Step S22).

When it is determined that the state of the relay link is a connection state from the results of the determination in Step S22 (Step S22: No), the relay link control unit 283 repeats the operations from Step S20.

Conversely, when it is determined that the state of the relay link is a disconnected state as a result of the determination in step S22 (Step S22: Yes), the notification information generating unit 5842 generates notification information instructing the stoppage of the wireless communication using the access link between the relay station 50 and the UE 30 and causes the access link transmitting unit 285 to transmit the notification information (Step S52). Additionally, the access link connection control unit 586 causes the access link transmitting unit 285 to transmit a downlink signal including the call disconnection message to the UE 30 connected to the relay station 50 (Step S53). The access link transmitting unit 285 transmits a downlink signal including the notification information and the call disconnect message to the UE 30 via the access link. The UE 30 that receives the downlink signal including the notification information and the call disconnect message recognizes the stoppage of the wireless communication between the UE 30 and the relay station 50 from the notification information and also recognizes the forced disconnection of the connection between the UE 30 and the relay station 50 from the call disconnect message. Thus, the UE 30 may stop wireless communication with the relay station 50. Moreover, the downlink synchronization evaluating unit 2836 sets the state of the relay station 50 to an out-of-cell state (Step S24). Next, the relay link control unit 283 repeats the operations from step S20.

Conversely, when it is determined that the state of the relay station 50 is not an in-cell state (Step S20: No) from the results of the determination in Step S20, the initial connection process implementing unit 2834 determines whether or not a new connectable eNB 10 near the relay station 50 is detected (Step S25).

When it is determined that a new connectable eNB 10 near the relay station 50 has not been detected from the results of the determination in step S25 (Step S25: No), the relay link control unit 283 repeats the operations from Step S20.

Alternatively, when the detection of a new connectable eNB 10 near the relay station 20 is determined from the results of the determination in Step S25 (Step S25: Yes), the initial connection process implementing unit 2834 conducts initial connection processing with the detected eNB 10 (Step S26). The initial connection process implementing unit 2834 then evaluates whether or not the connection processing is successful (Step S27).

When it is determined that the connection processing is not successful from the results of the determination in step S27 (Step S27: No), the relay link control unit 283 repeats the operations from Step S20.

Alternatively, when it is determined that the connection processing is successful as a result of the determination in step S22 (Step S27: Yes), the notification information generating unit 5842 generates notification information instructing the permission of the wireless communication using the access link between the relay station 50 and the UE 30 and causes the access link transmitting unit 285 to transmit the notification information (Step S54). The access link transmitting unit 285 transmits a downlink signal including the notification information to the UE 30 via the access link. The UE 30 that receives the downlink signal including the notification information recognizes the permission of wireless communication between the UE 30 and the relay station 50 from the notification information. Thus, the UE 30 may start or continue wireless communication with the relay station 50. Moreover, the downlink synchronization evaluating unit 2836 sets the state of the relay station 20 to the in-cell state (Step S29). Next, the relay link control unit 283 repeats the operations from step S20.

According to the wireless communication system 2 of the second embodiment as explained above, wireless communication using the access link between the UE 30 and the relay station 50 may be stopped when the relay link state between the eNB 10 and the relay station 50 is a disconnected state. In other words, when the relay link state is a disconnected state, wireless communication using the access link between the relay station 50 and the UE 30 may be selectively permitted. Thus, a desirable control of the problem of the user of the UE 30 continuing to conduct wasteful transmission operations is possible, and wasteful repeated transmissions from the UE 30 may be prevented. Therefore, unnecessary operations from the UE 30 side are reduced and convenience for the user is improved.

### (3) Third Embodiment

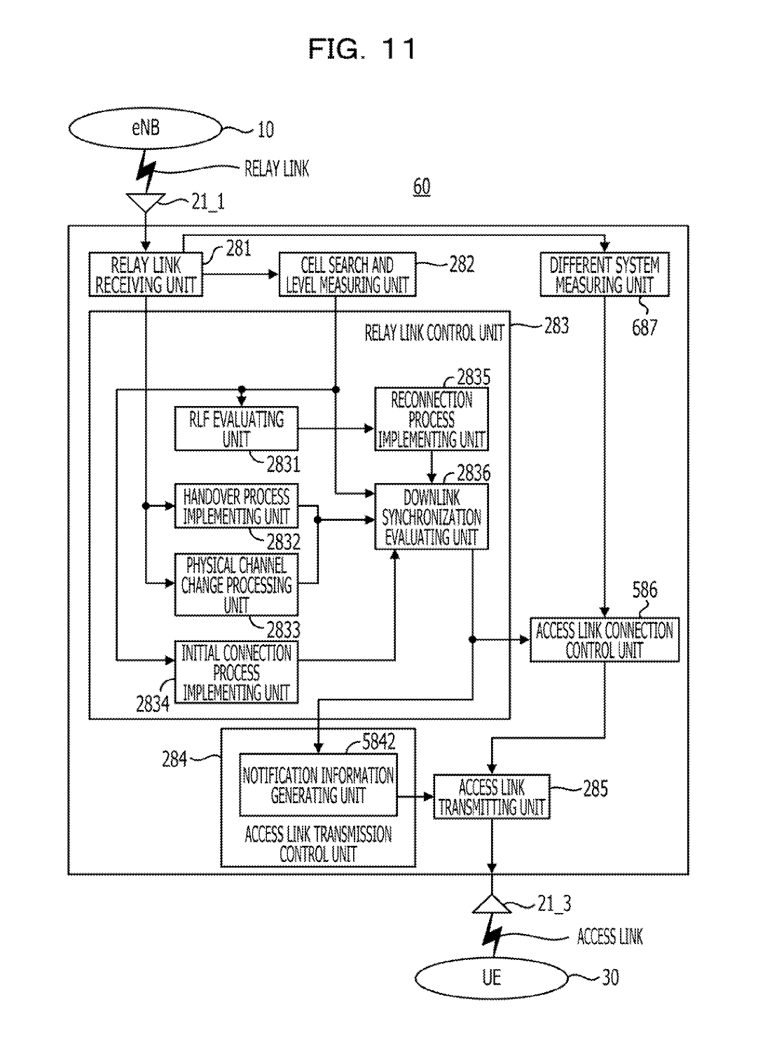

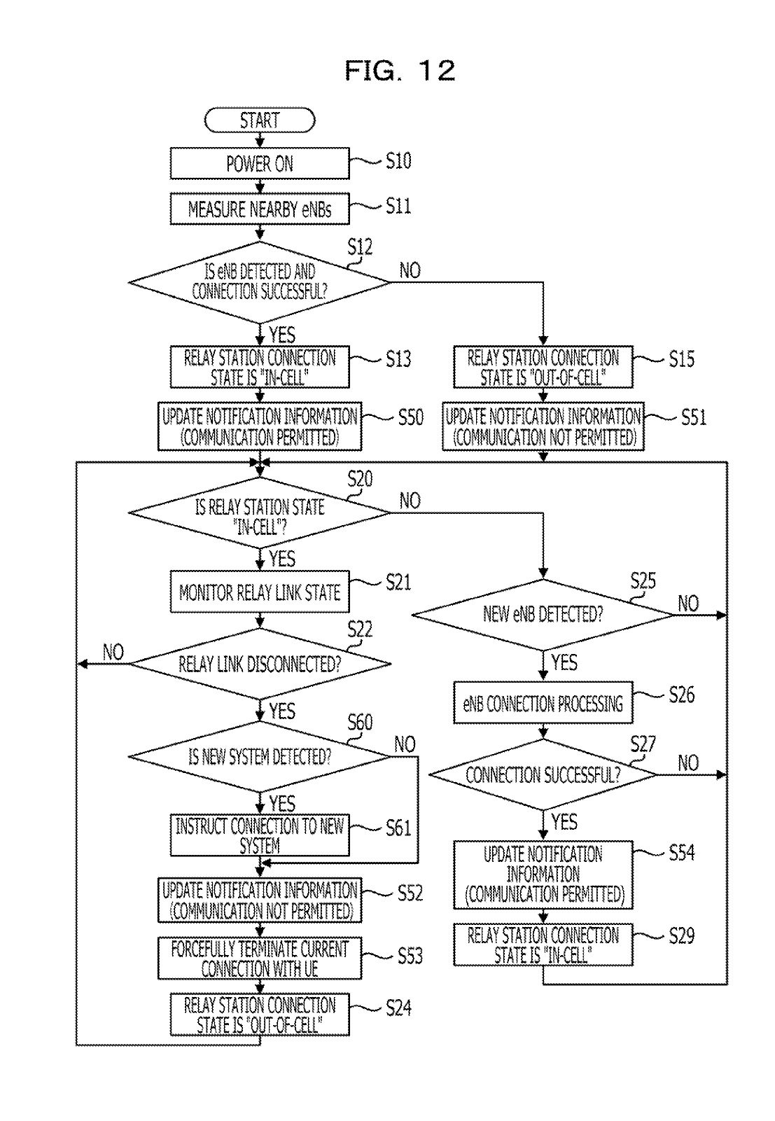

A wireless communication system according to a third embodiment will be explained herein with reference to FIGS. 11 and 12. Function blocks and operations of a relay station 60 the wireless communication system 3 of the third embodiment are different than those of the wireless communication system of the second embodiment. Hence, the following explanation will focus on the operations and configurations that are different from the second embodiment. Configurations and operations that are substantially the same as the wireless communication system 2 of the second embodiment are assigned the same reference numerals and their description is omitted here.

(3-1) Relay Station Function Block Diagram

Function blocks of the relay station 60 included in the wireless communication system 3 of the third embodiment will be explained with reference to FIG. 11. FIG. 11 is a block diagram of function blocks of the relay station 60 according to the third embodiment.

As illustrated in FIG. 11, the relay station 60 is equipped with the relay link receiving unit 281, the cell search and level measuring unit 282, the relay link control unit 283, the access link transmission control unit 284, and the access link transmitting unit 285, and the access link connection control unit 586 in substantially the same way as the relay station 50 of the second embodiment.

The relay station 60 of the third embodiment is further equipped with a different system measuring unit 687. The different system measuring unit 687 detects whether or not a wireless system different from the wireless communication system currently conducting wireless communication with the relay station 60 exists, based on the results received from the relay link receiving unit 281. For example, when the wireless communication system 3 currently conducting wireless communication with the relay station 60 is a wireless communication system that conforms to LTE, the different system measuring unit 687 determines whether or not, for example, a wireless communication system conforming to WiMAX or a wireless communication system WiFi or a wireless LAN exists.

The different system measuring unit 687 is a function block implemented, for example, by the measuring unit 2405_1 of the layer 1 processing unit 24_1 illustrated in FIG. 3 and FIG. 4A.

(3-2) Operation Explanation

Operations of the relay station 60 included in the wireless communication system according to the third embodiment will be explained with reference to FIG. 12. FIG. 12 is an exemplary flowchart of operations of the relay station 60 according to the third embodiment.

As illustrated in FIG. 12, operations of the relay station 60 of the third embodiment following the operation to monitor the state of the relay link (Step S21) and the operation to detect a relay link disconnection (Step S22) are different than the corresponding operations of the relay station 50 of the second embodiment. Other operations of the relay station 60 of the third embodiment are similar to the operations of the relay station 50 of the second embodiment. Specifically, in the third embodiment, when it is determined that the relay link is disconnected (Step S22: Yes), the access link connection control unit 586 uses information received from the different system measuring unit 687 to determine whether or not a different wireless communication system that can be connected to the UE 30 exists (Step S60). When it is determined that a different wireless communication system that can be connected to the UE 30 exists (Step S60: Yes), the relay station 60 transmits an instruction message to the UE 30 to conduct handover processing with the different wireless communication system as the handover target (Step S61). As a result, the UE 30 continues wireless communication by conducting the handover processing with the different wireless communication system. Conversely, when it is determined that there is no different wireless communication system with which the UE 30 may connect (Step S60: No), the handover instruction to the UE 30 is not conducted (Step S61) and the notification information is updated and call termination processing is conducted similar to the operations of the relay station 50 of the second embodiment.

According to the wireless communication system of the third embodiment as explained above, wireless communication using the access link between the UE 30 and the relay station 60 may be stopped when the relay link state between the eNB 10 and the relay station 60 is a disconnected state. Thus, a desirable control of the problem of the user of the UE 30 continuing to conduct wasteful transmission operations is possible, and wasteful repeated transmissions from the UE 30 may also be prevented. Therefore, unnecessary operations from the UE 30 side are reduced and convenience for the user is improved.

Additionally, according to the wireless communication system of the third embodiment, when the state of the relay link between the eNB 10 and the relay station 60 is a disconnected state and handover processing with a different wireless communication is possible, the relay station 60 may change the communication target of the UE 30 to the different wireless communication system. As a result, wireless communication of the UE 30 may be desirably continued.

### (1) Fourth Embodiment

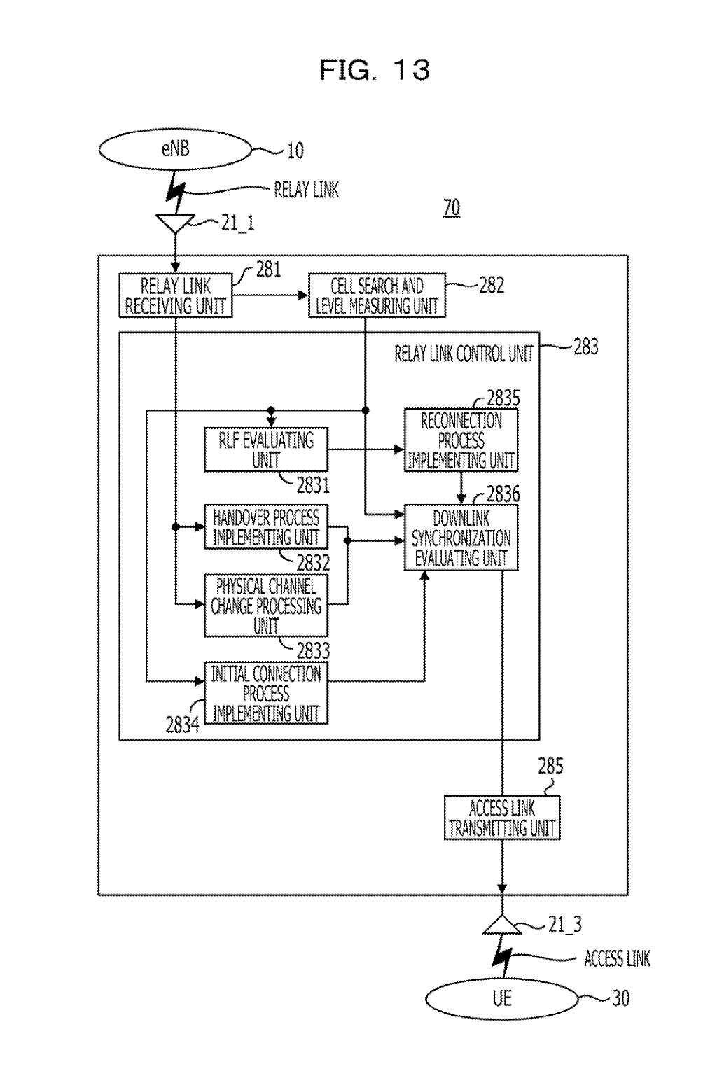

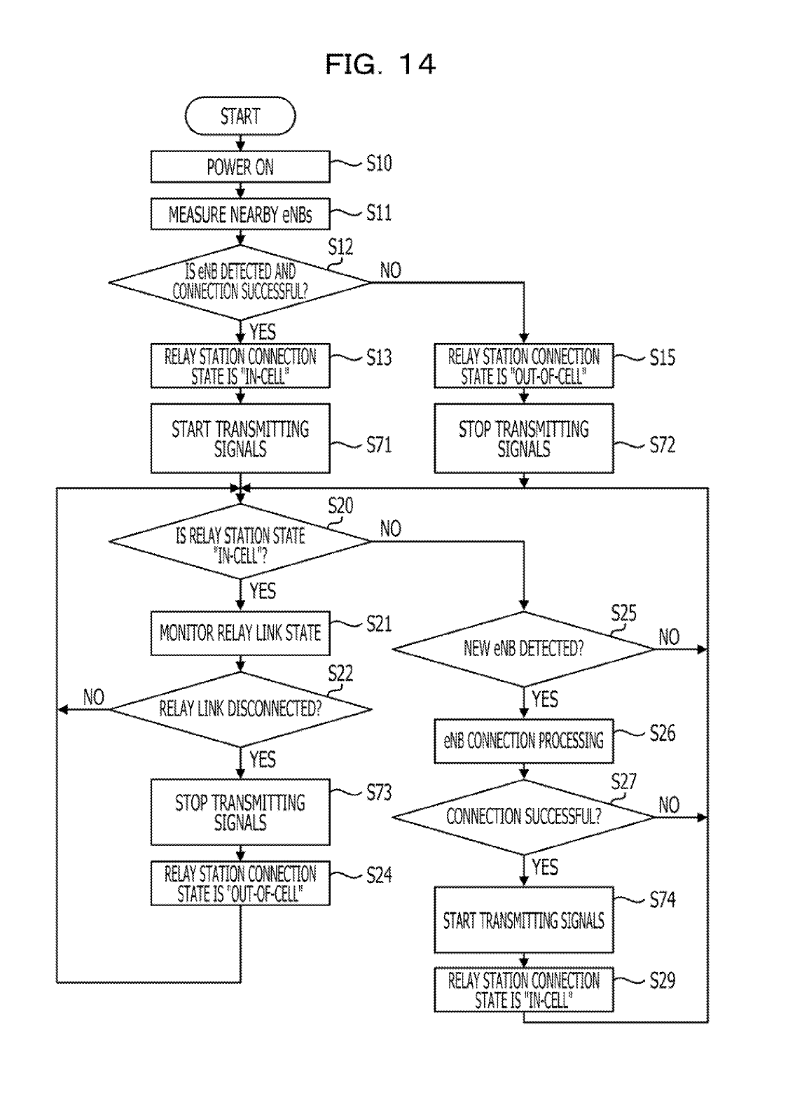

A wireless communication system according to a fourth embodiment will be explained herein with reference to FIGS. 13 and 14. Function blocks and operations of a relay station 70 of the wireless communication system of the fourth embodiment are different than those of the wireless communication system 1 of the first embodiment. Hence, the following explanation will focus on the operations and configurations that are different from the first embodiment. Configurations and operations that are substantially the same as the wireless communication system 1 of the first embodiment are assigned substantially the same reference numerals and their description is omitted here.

(4-1) Relay Station Function Block Diagram

Function blocks of the relay station 70 included in the wireless communication system of the fourth embodiment will be explained with reference to FIG. 13. FIG. 13 is a block diagram of function blocks of the relay station 70 according to the fourth embodiment.

As illustrated in FIG. 13, the relay station 70 is equipped with the relay link receiving unit 281, the cell search and level measuring unit 282, the relay link control unit 283, and the access link transmitting unit 285 in substantially the same way as the relay station 20 of the first embodiment. That is, the difference between the relay station 70 of the fourth embodiment and the relay station 20 of the first embodiment is that the relay station 70 is not equipped with the access link transmission control unit 284.

(4-2) Explanation of Operations

Operations of the relay station 70 included in the wireless communication system according to the fourth embodiment will be explained with reference to FIG. 14. FIG. 14 is an exemplary flowchart of operations of the relay station 70 according to the fourth embodiment.

Whereas the relay station 20 of the first embodiment stops transmission of the pilot signal and the synchronization signal when the state of the relay link is a disconnected state (see Steps S16 and S23 in FIG. 7) and starts transmission of the pilot signal and the synchronization signal when the state of the relay link is a connected state (see Steps S14 and S28 in FIG. 7), the relay station 70 of the fourth embodiment stops transmission of all downlink signals to the UE 30 from the relay station 70 when the state of the relay link is disconnected (Steps S27 and S73) and starts transmission of all downlink signals when the state of the relay link is connected (Steps S71 and S74), as illustrated in FIG. 14. Other operations of the relay station 70 of the fourth embodiment are similar to the operations of the relay station 20 of the first embodiment.

According to the wireless communication system of the fourth embodiment explained above, when the state of the relay link between the eNB 10 and the relay station 70 is a disconnected state, transmission of the downlink signals from the relay station 70 to the UE 30 may be stopped. As a result, the UE 30 may be switched to the out-of-cell state when the state of the relay link is disconnected. Thus, a desirable control of the problem of the user of the UE 30 continuing to conduct wasteful transmission operations is possible, and wasteful repeated transmissions from the UE 30 can also be prevented. Therefore, unnecessary operations from the UE 30 side are reduced and convenience for the user is improved.

Additionally, the abovementioned configurations and operations are applicable not only to a Decode and Forward (DF) type relay station, but also to an Amplify and Forward (AF) type relay station that amplifies and transmits received signals according to a wireless communication system 4 of the fourth embodiment. Thus, a relay station that may benefit with comparative ease from the abovementioned effects may be achieved.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has(have) been described in detail, it should be understood that the various changes, substitutions, and alterations could be made hereto without departing from the spirit and scope of the invention.

1. A relay station that relays wireless communication between a wireless base station and a mobile terminal, the relay station comprising:
a processor that detects a connection state of a first link between the wireless base station and the relay station in a wireless communication area, and controls a transmission of a signal using a second link between the mobile terminal and the relay station according to the state of the first link.

2. The relay station according to claim 1, wherein the processor controls (i) the state of the second link to not allow wireless communication via the second link when the first link is in a disconnected state, and controls (ii) the state of the second link to allow wireless communication via the second link when the first link is in a connected state.

3. The relay station according to claim 1, wherein the processor controls the state of the second link by stopping transmission of a synchronization signal and a pilot signal in a signal transmitted from the relay station to the mobile terminal via the second link when the first link is in a disconnected state.

4. The relay station according to claim 1, wherein the processor controls the state of the second link by stopping transmission of a signal transmitted from the relay station to the mobile terminal via the second link when the first link is in a disconnected state.

5. The relay station according to claim 1, wherein the processor controls the state of the second link by transmitting, to the mobile terminal via the second link, notification information that indicates that wireless communication is not being conducted, when the first link is in a disconnected state.

6. The relay station according to claim 5, wherein the mobile terminal that receives the notification information stops the wireless communication with the relay station via the second link, and the relay station that transmitted the notification information stops the wireless communication with the mobile terminal via the second link.

7. The relay station according to claim 1, wherein the processor detects the state of the first link by measuring quality of downward communication from the wireless base station to the relay station.

8. The relay station according to claim 1, wherein the processor detects the state of the first link from at least one of (i) a predetermined timing, (ii) a timing when a handover is conducted, and (iii) a timing when a physical channel parameter is changed.

9. A relay method for relaying communication between a wireless base station and a mobile terminal, the relay method comprising:
detecting a connection state of a first link between the wireless base station and a relay station in a wireless communication area, and
controlling a transmission of a signal using a second link between the mobile terminal and the relay station according to the state of the first link.

10. A wireless communication system, comprising:
a wireless base station;
a mobile terminal; and
a relay station that relays communication between the wireless base station and the mobile terminal, wherein
the relay station includes a processor that detects a connection state of a first link between the wireless base station and the relay station in a wireless communication area, and controls a transmission of a signal using a second link between the mobile terminal and the relay station according to the state of the first link.
